(19) United States
(12) Patent Application Publication
(10) Pub. No.: US 2026/0184202 A1
(43) Pub. Date: Jul. 2, 2026

(54) MODULE IN PARTICULAR FOR THE ELECTRIC CHARGING OF AN ELECTRIC VEHICLE

(71) Applicant: CEBI ITALY S.P.A., DRONERO (CN) (IT)

(72) Inventors: Eugenio Guglielmo D’URSO, OSIMO (AN) (IT); Simone DI CORI, CASTELFIDARDO (AN) (IT); Sergio FROLLI, COMO (IT); Fabio LUCANGELI, PORTO SAN GIORGIO (FM) (IT); Davide SORAVIA, CERMENATE (CO) (IT)

(21) Appl. No.: 19/424,387

(22) Filed: Dec. 18, 2025

(30) Foreign Application Priority Data
Dec. 19, 2024 (IT) 102024000029259

(51) Int. Cl. B60L 53/16

(52) U.S. Cl. CPC B60L 53/16

(57) ABSTRACT

A module in particular for the electric charging of an electric vehicle, comprising a box-shaped housing having a seat with an access opening, a lid having a closing plate suitable for closing the access opening of the housing, a drive mechanism suitable for moving the lid from a closed position, wherein the closing plate of the lid closes the access opening of the housing, to an inwardly open position, wherein the closing plate is disposed inside the seat of the housing, an actuator that operates the drive mechanism, and a detector suitable for detecting when the lid is moved with respect to the closed position.

### CROSS-REFERENCE TO RELATED APPLICATIONS

Not applicable.

### FIELD OF THE INVENTION

The present invention relates to a module, in particular for the electric charging of an electric vehicle, but also for refueling.

### BACKGROUND OF THE INVENTION

Vehicles are equipped with modules comprising a housing and a lid that is hinged to the housing. An opening is provided in the housing that is suitable for accommodating a tube in communication with a fuel tank of the vehicle or an electric charging connector in communication with a power supply of the vehicle. An actuator locks the lid in closed position. These actuators are push-type actuators. This means that when the lid is closed, the user pushes the lid and the actuator unlocks the lid.

It should be noted that the hinge system used in the modules of the prior art only allows the lid to rotate outwards to open the lid. However, especially in the case of an electric charging module wherein the lid is large, a simple rotation of the lid does not ensure the proper tight closing of the lid against the housing.

This problem is at least partially solved by articulated quadrilateral mechanisms that allow a roto-translation of the lid with respect to the housing.

EP1018588A1 discloses a door connected to the housing by means of two levers in such a way to form an articulated quadrilateral and an actuator separate from the levers of the articulated quadrilateral that operates the door directly. The fact that the actuator operates the lid and not the articulated quadrilateral mechanism causes problems with space inside the housing of the module. As a result, such a type of door must open outwards with respect to the housing. Consequently, when the door is open, the door protrudes from the housing, limiting the maneuvering space for the operator who has to carry out the electric charging or refueling.

U.S. Pat. No. 10,352,078B2 discloses an articulated quadrilateral mechanism of a charging flap that comprises two levers suitable for connecting the charging flap to the housing. An actuator actuates a spring device that actuates the levers of the articulated quadrilateral mechanism. The spring device is operated both during the opening and the closing of the charging flap. Such an actuation mechanism is complicated and space-consuming due to the provision of an additional elastic element that is actuated during the opening and the closing of the door. Moreover, such a type of charging flap must open outwards with respect to the housing, in such a way that, when it is open, the charging flap protrudes from the housing, thus limiting the maneuvering space for the operator who has to carry out the recharging or refueling.

U.S. Pat. No. 8,439,421 discloses a module for a fuel lid of a vehicle.

### SUMMARY OF THE INVENTION

The purpose of the present invention is to eliminate the drawbacks of the prior art by providing a module, in particular for the electrical recharging of an electric vehicle, with a drive mechanism of the fuel lid that is compact, simple, and composed of a reduced number of parts, in such a way that the fuel lid can be opened towards the inside of the housing.

Another purpose of the present invention is to provide such a module with a drive mechanism of the lid that is safe, efficient, reliable, versatile, and simple to make.

These purposes are achieved in accordance with the invention with the characteristics of the attached independent claims.

Advantageous embodiments of the invention appear from the dependent claims.

### BRIEF DESCRIPTION OF DRAWINGS

Additional features of the invention will become clearer from the following detailed description, which refers to a merely illustrative and therefore non-limiting embodiment, illustrated in the accompanying drawings.

FIG. 1 is a perspective view, illustrating the module according to the invention, with the lid in the open position.

FIG. 2 is a perspective view of the module of FIG. 1, with the lid in the closed position.

FIG. 3 is a top view, illustrating the lid and the operating mechanism of the module according to the invention.

FIG. 4 is a side view of the lid and of the operating mechanism.

FIG. 5 is a perspective view of the lid and of the operating mechanism.

FIG. 5A is a view like FIG. 5, except for the fact that it also illustrates an actuator and detection means of the lid.

FIG. 5B is a perspective rear view of the lid of FIG. 5A.

FIG. 5C is a partially sectional view of a detail of the module illustrating the microswitch of the detection means in closed contact position.

FIG. 5D is a view like FIG. 5C, illustrating the microswitch of the detection means in open contact position.

FIGS. 6 and 6A are respectively a side view and a perspective view, illustrating the operating mechanism and the lid in closed position.

FIGS. 7 and 7A are views like FIGS. 6 and 6A, except for the fact that they illustrate the operating mechanism and the lid when the lid is pushed to open.

FIGS. 8 and 8A are views like FIGS. 6 and 6A, except for the fact that they illustrate the operating mechanism and the lid during a first opening step.

FIGS. 9 and 9A are views like FIGS. 6 and 6A, except for the fact that they illustrate the operating mechanism and the lid during a second opening step.

FIGS. 10 and 10A are views like FIGS. 6 and 6A, except for the fact that they illustrate the operating mechanism and the lid in open position.

### DETAILED DESCRIPTION OF THE INVENTION

With the aid of the Figures, the module according to the invention, which is generally indicated with reference numeral 100, is described.

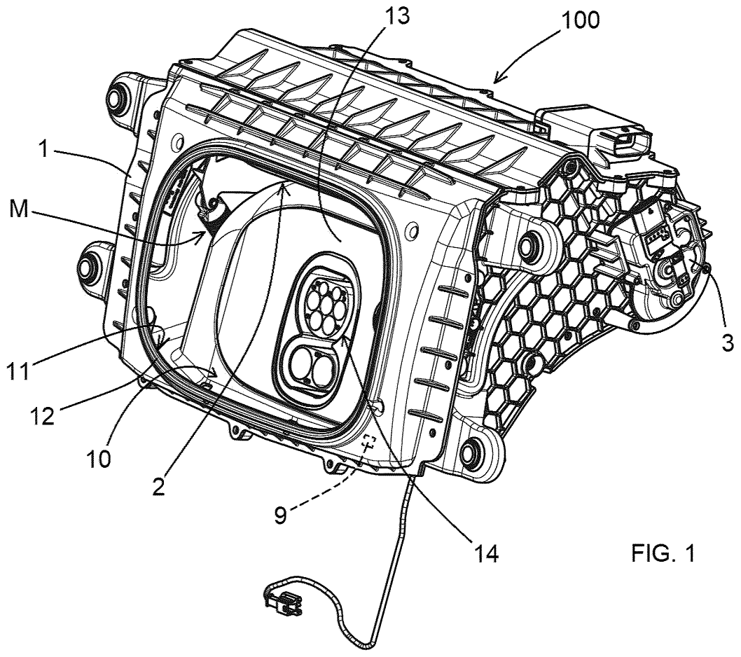

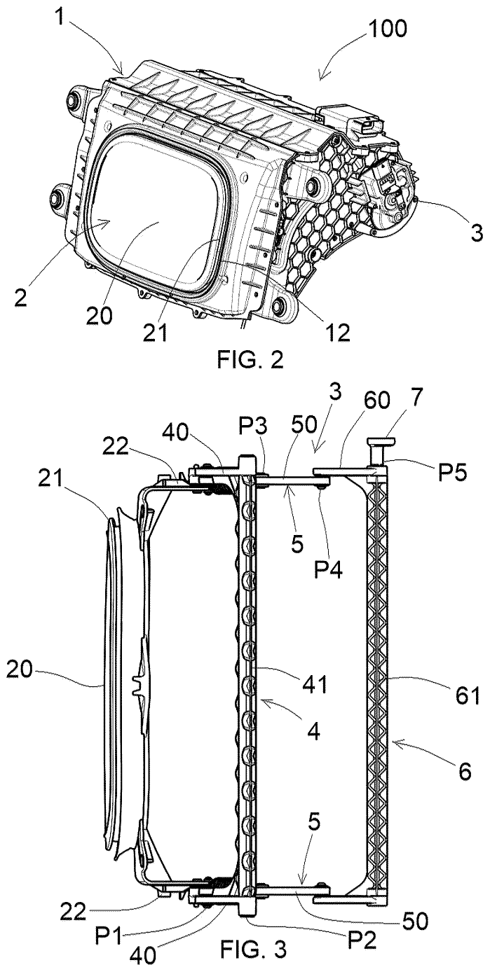

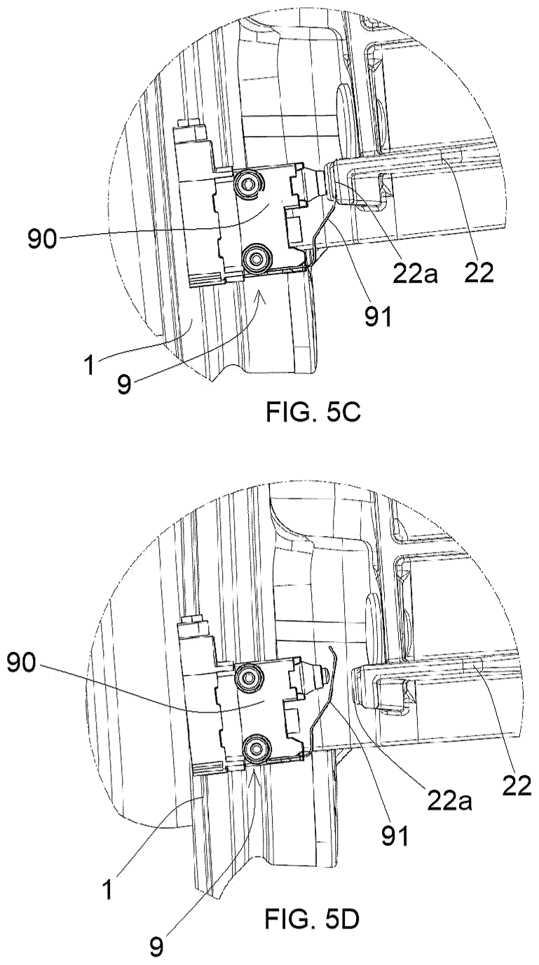

For now, with reference to FIGS. 1 and 2, the module (100) comprises:
a box-shaped housing (1) having a seat (10) with an access opening (11);
a lid (2) having a closing plate (20) suitable for closing the access opening (11) of the housing;
a drive mechanism (M) (FIGS. 5A and 5B) suitable for moving the lid (2) from a closed position (FIG. 2), wherein the closing plate (20) of the lid closes the access opening (11) of the housing, to an inwardly open position (FIG. 1), wherein the closing plate (20) is disposed inside the seat (10) of the housing; and
an actuator (3) that operates the drive mechanism (M).

A first seal (12) is disposed in an edge of the housing that defines the access opening (11), and a second seal (21) is disposed in an edge of the closing plate. In this way, when the closing plate (20) of the lid closes the access opening (11) of the housing, the seals (12, 21) are compressed tightly.

A back wall (13) is provided in the seat (10) of the housing, wherein an electric charging or refueling system (14) is arranged, which may comprise an electrical connector connected to batteries of the vehicle or a tube connected to a fuel tank of the vehicle.

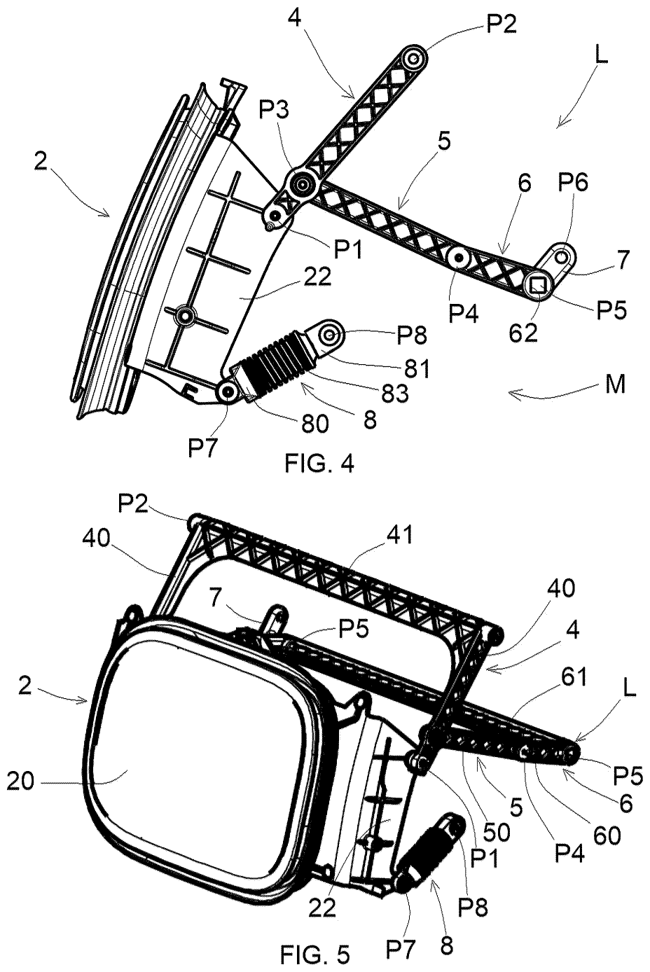

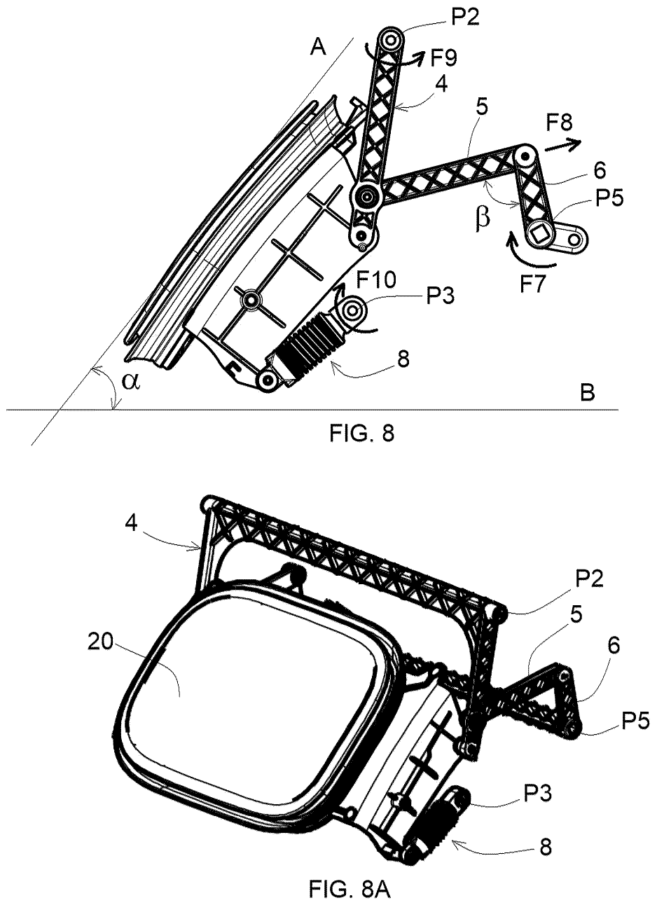

With reference to FIGS. 3 and 8A, the lid (2) comprises two brackets (22) that protrude posteriorly from two opposite sides of the closing plate (20).

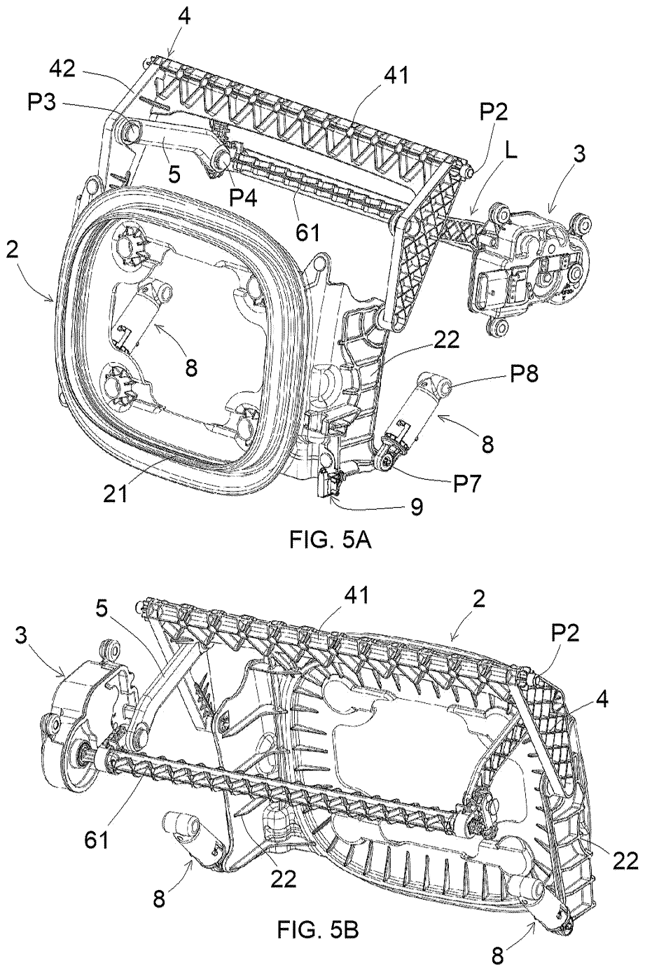

With reference to FIG. 4, the drive mechanism (M) comprises:
a first lever (4) hinged to the brackets (22) of the lid and to the housing (1) inside the seat (10) of the housing;
two shock absorbers (8) hinged to the brackets (22) of the lid and to the housing (1) inside the seat (10) of the housing; and
a connection linkage (L) connected to the first lever (4) and to the actuator (3).

In view of the above, an articulated quadrilateral is formed, wherein the four sides of the articulated quadrilateral are: the lid (2), the first lever (4), the housing (1), and the shock absorbers (8). As a result, the lid (2) can roto-translate in such a way as to open or close the access opening (11) of the housing.

It should be noted that the shock absorbers (8) form one side of the articulated quadrilateral and are not separated from the sides of the articulated quadrilateral, resulting in a considerable space saving.

The first lever (4) has a first end hinged to the brackets (22) with a first hinging axis (P1) disposed in an upper part of the brackets (22), and a second end hinged to the housing with a second hinging axis (P2).

With reference to FIGS. 3 and 4, the first lever (4) has a U-shape comprising two legs (40) and a crosspiece (41). The two legs (40) of the first lever are hinged to the brackets (22) of the lid along the first hinging axis (P1) and the crosspiece (41) is hinged to the housing (1) along the second hinging axis (P2).

Each shock absorber (8) is a spring shock absorber, comprising a first portion (80) hinged to the bracket (22) of the lid, a second portion (81) hinged to the housing, and a spring (83) arranged between the first portion (80) and the second portion (81) of the shock absorber. The spring (83) is a coil spring that works in compression. The first portion (80) of the shock absorber slides with respect to the second portion (81) so as to compress the spring (83).

The connection linkage (L) comprises a rod-crank mechanism, comprising a crank (6) connected to the actuator (3) and a connecting rod (5) hinged to the first lever (4).

The connecting rod (5) has a first end hinged to the first lever (4) with a third hinging axis (P3) disposed in the proximity of the first hinging axis (P1) and a second end hinged to the crank (6) with a fourth hinging axis (P4).

The crank (6) has a first end hinged to the connecting rod (5) with the fourth hinging axis (P4) and a second end having a hole (62) wherein a shaft of the actuator (3) is fitted in such a way that said shaft of the actuator can rotate about a fifth hinging axis (P5).

The connection linkage (L) also comprises a second lever (7) having a first end hinged to the crank (6) with the fifth hinging axis (P5) and a second end hinged to the housing (1) with a sixth hinging axis (P6).

The connecting rod (5) comprises two rods (50) hinged to the legs (40) of the first lever.

The crank (6) has a U-shape comprising two legs (60) and a crosspiece (61). The two legs (60) of the crank are hinged to the rods (50) of the connecting rod. The rotating shaft of the actuator (3) is fitted to the crosspiece (61) of the crank, as shown in FIGS. 5A and 5B.

The second lever (7) is a single rod that is hinged at one end to the crosspiece (61) of the crank and to the housing (1).

The module (100) further comprises detection means (9) (shown in FIG. 1 with a broken line) suitable for detecting when the lid is moved with respect to the closed position. Otherwise said, the detection means (9) are suitable for detecting a push movement of the lid (2).

With reference to FIGS. 5A, 5C, and 5D, the detection means (9) comprise a microswitch (90) disposed in the housing (10) of the module.

With reference to FIG. 5C, the microswitch (90) has a plate (91) that is compressed by a protrusion (22a) of a bracket (22) of the lid when the lid is in closed position. Therefore, when the lid (2) is in closed position, the microswitch (90) is a closed contact.

With reference to FIG. 5D, when the lid (2) is moved from the closed position, the bracket (22) releases the plate (91) of the microswitch and the microswitch (90) changes its status and becomes an open contact.

The detection means (9) are operatively connected to a control unit of the vehicle that is informed about the position of the lid.

The operation of the module (100) according to the invention is described below.

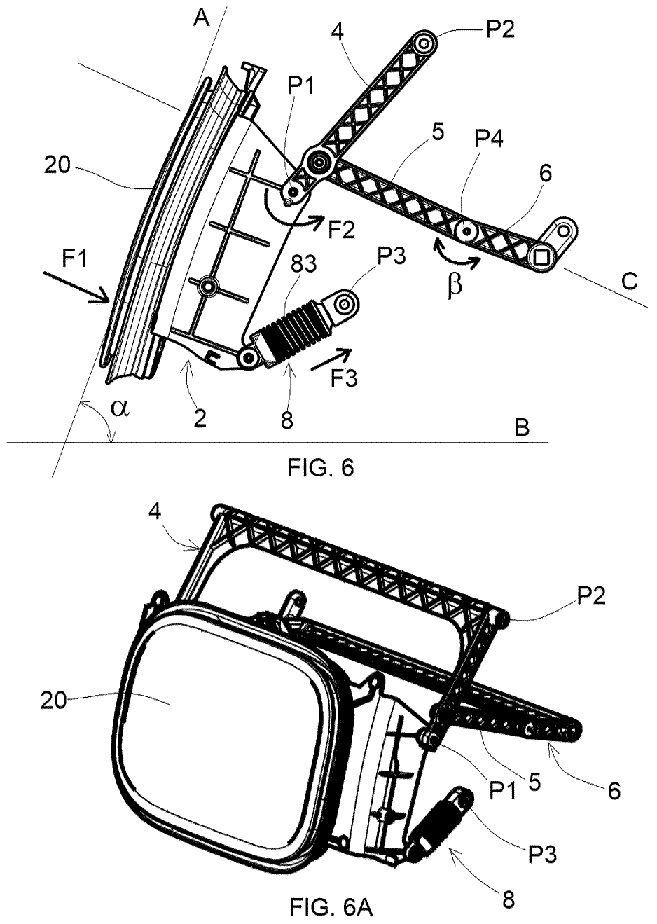

With reference to FIG. 6, the lid (2) is in closed position. A tangent axis to the closing plate (20) of the lid is indicated with letter A and a horizontal axis with letter B. When the lid is in closed position, the tangent axis (A) of the lid is inclined by an angle (α) of approximately 70° with respect to the horizontal axis (B).

The connecting rod (5) and the crank (6) are aligned along an axis (C) perpendicular to the tangent axis (A), meaning that an angle (β) of 180° is provided between the connecting rod (5) and the crank (6). In this way, when they are aligned, the connecting rod (5) and the crank (6) prevent the first lever (4) from rotating about the second hinging axis (P2) in the event of the lid (2) being pushed from the outside.

To open the lid, the operator manually pushes the lid in the direction of the arrow F1. Consequently, the lid (2) rotates about the first hinging axis (P1) in the direction of the arrow F2, whereas the first lever (4) remains stationary because it is locked by the rod-crank mechanism. As a result, the shock absorbers (8) are compressed in the direction of the arrow F3. The detection means (9) detect the push and send the information to the control unit of the vehicle.

When the user releases the lid, the shock absorbers (8) are unloaded, pushing the lid back towards the closed position, as shown in FIG. 6. Then the detection means (9) detect that the lid has returned to the closed position and inform such an event to the control unit of the vehicle, which actuates the actuator (3), thus bringing the lid to the open position.

It should be noted that the actuator (3) is activated after the user has pushed the lid (2) once.

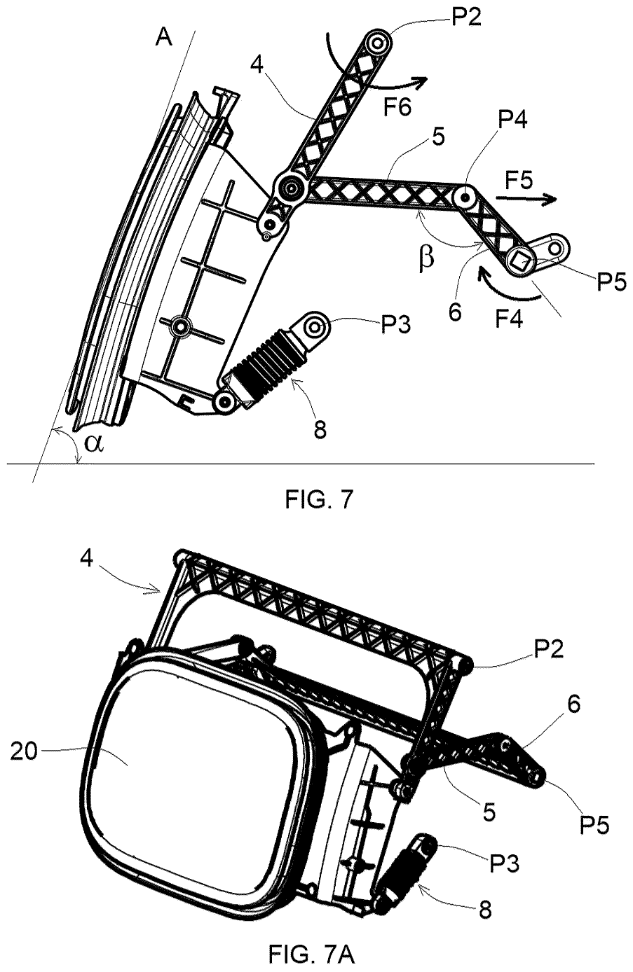

With reference to FIG. 7, the drive shaft of the actuator (3) begins to rotate clockwise in the direction of the arrow F4. Then the crank (6) rotates in the direction of the arrow F4 about the fifth hinging axis (P5), pushing the connecting rod (5) in the direction of the arrow F5. As a result, the first lever (4) rotates in the direction of the arrow F6 about the second hinging axis (P2).

The angle (β) between the connecting rod (5) and the crank (6) decreases. Conversely, the angle (α) between the tangent axis (A) of the lid and the horizontal axis (B) remains unchanged.

With reference to FIG. 8, continuing to rotate the shaft of the actuator (3), the crank (6) rotates in the direction of the arrow F7 about the fifth hinging axis (P5), pushing the connecting rod (5) in the direction of the arrow F8. As a result, the first lever (4) rotates in the direction of the arrow F9 about the second hinging axis (P2). The angle (β) between the connecting rod (5) and the crank (6) decreases.

The lid (2) begins to roto-translate due to the combined movement of the first lever (4) and of the shock absorbers (8) that rotate in the direction of the arrow F10 about the third hinging axis P3. In fact, the angle (α) between the tangent axis (A) of the lid and the horizontal axis (B) decreases to approximately 55°.

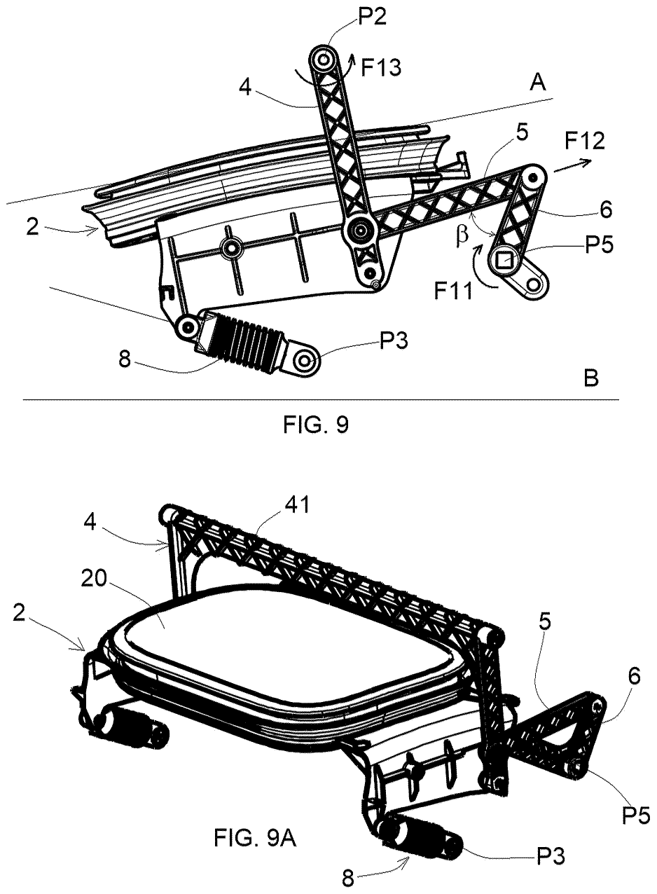

With reference to FIG. 9, continuing to rotate the shaft of the actuator (3), the crank (6) rotates in the direction of the arrow F11 about the fifth hinging axis (P5), pushing the connecting rod (5) in the direction of the arrow F12. As a result, the first lever (4) rotates in the direction of the arrow F13 about the second hinging axis (P2). The angle (β) between the connecting rod (5) and the crank (6) decreases.

The lid (2) performs a roto-translation due to the combined movement of the first lever (4) and of the shock absorbers (8). From the position in FIG. 8 to the position in FIG. 9, the shock absorbers (8) have made a rotation higher than 90°.

The angle (α) between the tangent axis (A) of the lid and the horizontal axis (B) decreases to approximately 15°. In such a situation, the closing plate (20) of the lid begins to position itself under the crosspiece (41) of the first lever (4). Since the crosspiece (41) of the first lever is located inside the seat (10) of the housing of the module, the lid (2) begins to enter the housing of the module.

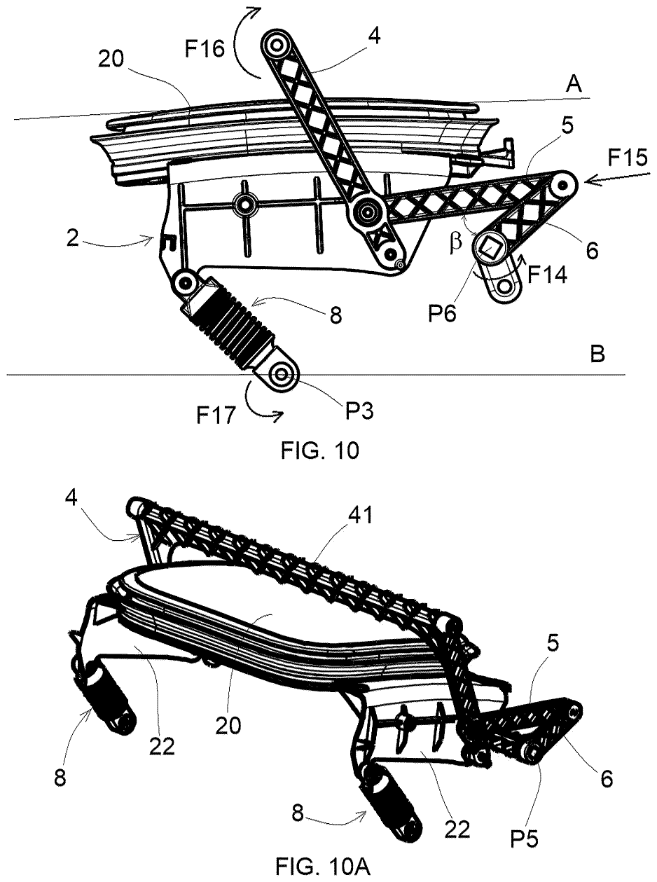

FIG. 10 shows the lid (2) is open position, wherein the lid (2) is completely contained inside the seat (10) of the housing of the module.

In such a situation, the tangent axis (A) of the lid is almost parallel to the horizontal axis (B). The angle (β) between the connecting rod (5) and the crank (6) is at its minimum value of approximately 30°-35°.

It should be noted that, when moving from the initial closed position shown in FIG. 6 to the final open position shown in FIG. 10, the first lever (4) has rotated counterclockwise by approximately 60° and the shock absorbers (8) have rotated clockwise by approximately 90°.

Starting from the open position shown in FIG. 10, if the operator intends to close the lid (2), the operator sends a control signal to the control unit of the vehicle by means of a button disposed, for example, on the back wall (13) of the housing or by means of a remote control. The control unit of the vehicle activates the actuator (3) that rotates its shaft counterclockwise in the direction of the arrow F14. The crank (6) rotates in the direction of the arrow F14 about the fifth hinging axis (P5), pushing the connecting rod (5) in the direction of the arrow F15. As a result, the first lever (4) rotates in the direction of the arrow F16 about the second hinging axis (P2), and the shock absorbers (8) rotate in the direction of the arrow F17 about the third hinging axis (P3). As a result, the lid (2) performs a roto-translation and is moved to the closed position shown in FIG. 7.

Numerous variations and detailed modifications can be made to the present embodiment of the invention, within the reach of a person skilled in the art, however falling within the scope of the invention as expressed by the appended claims.

1. A module, in particular for the electric charging of an electric vehicle, comprising:
a box-shaped housing having a seat with an access opening;
a lid having a closing plate suitable for closing the access opening of the housing;
a drive mechanism suitable for moving the lid from a closed position, wherein the closing plate of the lid closes the access opening of the housing, to an inwardly open position, wherein the closing plate is disposed inside the seat of the housing, the drive mechanism comprising:
a first lever hinged to the lid and to the housing inside the seat of the housing; and
two shock absorbers hinged to the lid and to the housing inside the seat of the housing; in such a way to create an articulated quadrilateral wherein the four sides are: the lid, the first lever, the housing, and the shock absorbers; as a result, the lid can roto-translate in order to open or close the access opening of the housing; and
an actuator that operates the drive mechanism;
detection means suitable for detecting when the lid is moved with respect to the closed position;
said drive mechanism comprising a connection linkage connected to the first lever of the articulated quadrilateral and to the actuator.

2. The module of claim 1, wherein said shock absorbers form one side of the articulated quadrilateral and are configured to allow a push-type movement of the lid from the closed position.

3. The module of claim 2, wherein said detection means are configured to detect said push-type movement of the lid and accordingly inform said push-type movement to a control unit of the vehicle that actuates said actuator in order to move the lid to its open position.

4. The module of claim 3, wherein said detection means comprise a microswitch disposed in the housing of the module; said microswitch having a plate that is compressed by a bracket of the lid when the lid is in closed position.

5. The module of claim 1, wherein each shock absorber is a spring shock absorber comprising a first portion hinged to the lid, a second portion hinged to the housing, and a spring arranged between the first portion and the second portion of the shock absorber; said spring being a coil spring that works in compression; and the first portion of the shock absorber being suitable for sliding relative to the second portion so as to compress the spring.

6. The module of claim 1, wherein the connection linkage comprises a rod-crank mechanism, comprising a crank connected to the actuator and a connecting rod hinged to the first lever.

7. The module of claim 6, wherein said actuator is a rotary actuator having a rotary shaft that is fitted to the crank in order to rotate the crank.

8. The module of claim 1, wherein said lid has two brackets protruding from said closing plate and the first lever has a U-shape comprising two legs and a crosspiece. The two legs of the first lever are hinged to the brackets of the lid along a first hinging axis, and the crosspiece of the first lever is hinged to the housing along the second hinging axis.

9. The module of claim 8, wherein said connecting rod comprises two rods hinged to the legs of the first lever.

10. The module of claim 9, wherein said crank has a U-shape comprising two legs and a crosspiece, the two legs of the crank being pivoted to the rods of the connecting rod, and said rotary shaft of the actuator being fitted to said crosspiece of the crank.
